(19) United States
(12) Patent Application Publication
(10) Pub. No.: US 2024/0152627 A1
(43) Pub. Date: May 9, 2024

(54) Method for Determining the Integrity of a Data Processing Operation, Device, and Data Processing Installations

(71) Applicant: Siemens Aktiengesellschaft, München (DE)

(72) Inventors: Rainer Falk, Erding (DE); Hans Aschauer, München (DE); Omar Belhachemi, München (DE); Christian Peter Feist, München (DE); Hermann Seuschek, München (DE); Thomas Zeschg, München (DE)

(73) Assignee: Siemens Aktiengesellschaft, München (DE)

(21) Appl. No.: 18/549,069

(22) PCT Filed: Mar. 1, 2022
(86) PCT No.: PCT/EP2022/055168

§ 371 Date: Sep. 5, 2023

(30) Foreign Application Priority Data
Mar. 11, 2021 (EP) 21161908.5

(51) Int. Cl. G06F 21/57; G06F 21/60

(52) U.S. Cl. CPC G06F 21/577; G06F 21/602

(57) ABSTRACT

Various embodiments of the teachings herein include a method for determining the integrity of data processing of operative data using a trusted execution environment. The method may include: presenting the trusted execution environment with input data including the operative data and test data; processing the input data to produce output data; subjecting that portion of the output data formed by the processed test data to a comparison with reference data; and using the comparison as a basis for determining the integrity of the data processing.

### CROSS-REFERENCE TO RELATED APPLICATIONS

This application is a U.S. National Stage Application of International Application No. PCT/EP2022/055168 filed Mar. 1, 2022, which designates the United States of America, and claims priority to EP Application No. 21161908.5 filed Mar. 11, 2021, the contents of which are hereby incorporated by reference in their entirety.

### TECHNICAL FIELD

The present disclosure relates to data processing. Various embodiments of the teachings herein include systems and/or methods for determining the integrity of data processing of operative data by means of a trusted execution environment.

### BACKGROUND

Confidential computing, in particular by means of trusted execution environments, which are also called enclaves, facilitates the data processing of sensitive data in encrypted form. Confidential computing results in the data to be processed not being available in clear text on a platform, in particular in a main memory (RAM), even during the data processing. Confidential computing is therefore used to maintain the confidentiality of the data to be processed during the actual data processing too.

The data in trusted execution environments such as these are certainly protected during their data processing. However, there is also no or only very limited opportunity to monitor and verify the correctness or the integrity of the data processing within a trusted execution environment such as this.

In embedded systems, in particular in safety-critical systems, watchdogs are known that monitor the hardware of the embedded systems in the course of operation and enforce a restart in the event of error. Side channel attacks, specifically on implementations of crypto algorithms, are also known. Power fingerprinting is known in order to monitor a device on the basis of the electromagnetic radiation or power consumption profile thereof (https://www.pfpcyber.com/how-it-works/).

It is known, for example in the case of Intel SGX as a trusted execution environment, that the trusted execution environment notifies an external system or another enclave of which application, also referred to as an app, is executed in the trusted execution environment. However, this does not involve a check on whether a trusted execution environment executes the data processing as expected, e.g. the integrity of the data processing is not checked. There is therefore still a need to better determine the integrity of a trusted execution environment.

Trusted execution environments known to date are thus certainly able to protect the confidentiality of the data processing, with the result that even sensitive data, for example confidential data, which, like patient data, need to meet in particular data protection requirements, and/or construction data and/or operating data from a production facility can be processed without compromising the confidentiality thereof. However, the integrity of the data processing cannot be guaranteed in trusted execution environments known to date, and so it is not known whether output data from the data processing have been correctly ascertained. That is to say that a correctly operating technical realization of the trusted execution environment and program code correctly executed thereon are not guaranteed.

### SUMMARY

The teachings of the present disclosure include methods and/or systems for determining the integrity of data processing of operative data by means of a trusted execution environment apparatus for determining data processing of operative data by means of trusted data processing. For example, some embodiments include a method for determining the integrity of data processing of operative data by means of a trusted execution environment (TEE), wherein the trusted execution environment (TEE) is presented with input data (ID) that comprise the operative data (OD) and test data (TD), the input data (ID) being processed by means of the data processing to produce output data (OUD), and that portion of the output data (OUD) that is formed by the processed test data (PTD) being subjected to a comparison (TDV) with reference data (RD) and the comparison (TDV) being taken as a basis for determining the integrity of the data processing.

In some embodiments, the integrity of the data processing is established, and is displayed by means of a user interface (TPOD), if the reference data (RD) match the processed test data (PTD).

In some embodiments, the data processing takes place in an encrypted manner.

In some embodiments, the operative data (OD) and the test data (TD) are merged according to a predefined sequence or order to produce input data (ID).

In some embodiments, the operative data (OD) and the test data (TD) are merged randomly and/or pseudorandomly in respect of a sequence or order to produce input data (ID).

In some embodiments, the processed test data (PTD) are extracted from the output data (OUD) on the basis of the sequence or order.

In some embodiments, the test data (TD) form a portion of the input data (ID) that has no need of the data processing by means of the trusted execution environment (TEE).

As another example, some embodiments include an apparatus, in particular computer program product, that is designed to carry out one or more methods as described herein.

As another example, some embodiments include a data processing installation having an apparatus as described herein.

As another example, some embodiments include a plant, in particular a production and/or machining plant and/or an autonomous vehicle and/or a medical device, e.g. a modality device, having a data processing installation as described herein.

### BRIEF DESCRIPTION OF THE DRAWINGS

The teachings of the present disclosure is explained in more detail below on the basis of an exemplary embodiment shown in the drawing.

The FIGURE shows an example apparatus for determining the integrity of data processing of operative data by means of a trusted execution environment incorporating teachings of the present disclosure.

### DETAILED DESCRIPTION

Some embodiments of the teachings of the present disclosure include a method for determining the integrity of data processing of operative data by means of a trusted execution environment involves the trusted execution environment being presented with input data that comprise the operative data and test data, the input data being processed by means of the data processing to produce output data, and that portion of the output data that is formed by the processed test data being subjected to a comparison with reference data and the comparison being taken as a basis for determining the integrity of the data processing.

Trusted execution environments for the purposes of this invention are in particular isolated execution environments that may comprise at least one Intel SGX processor and/or at least one ARM processor and/or at least one TrustZone processor and/or at least one AMD processor and/or at least one RISC-V processor. A trusted execution environment is preferably an execution environment that is logically separate on a processor, e.g. isolated from a regular execution environment.

It may be isolated logically, but may be on a hardware basis. However, it may also be realized as a standalone hardware unit, for example as a separate processor core, on a processor. The trusted execution environment may implement memory encryption, e.g. AMD SME/SVE and/or Intel TME/MKTME and/or a homomorphic memory encryption. The trusted execution environment may be a confidential execution environment (confidential computing environment) in which, during the processing of data, the data are available in cryptographically encrypted form or in an obfuscated form, and so they are not available in clear text in a main memory. The confidential execution environment is an execution environment that is also referred to as a trusted execution environment.

The input data used are therefore not the actual operative data alone, but rather the operative data have the test data added. The test data are merged and may be “interwoven” with the operative data to form the input data for the trusted execution environment. The output data that are output by the trusted execution environment are subsequently separated to form one data stream of processed test data and another data stream of processed operative data. The processed test data are subjected to a check on the basis of reference data. If the result of the check is that the data processing of the test data has integrity, the data processing of the operative data is regarded as having integrity.

In some embodiments, the method includes the integrity of the data processing being established if the reference data match the processed test data, and the integrity is displayed by means of a user interface. There may be provision for digital determination of the integrity, having integrity or not having integrity. In some embodiments, a degree of integrity can be determined and displayed, that is to say an integrity above a stipulated threshold value or an integrity that indicates a specific probability of complete integrity.

The method can involve the data processing taking place in an unencrypted manner. In some embodiments, the method involves the data processing taking place in an encrypted manner. Encrypted data processing means data processing in which the data to be processed by means of the data processing are available in a memory, such as in particular a main memory or RAM, in encrypted form during the data processing. In some embodiments, the method for determining integrity can be used with the advantages described here.

In some embodiments, the method involves the operative data and the test data being merged according to a predefined sequence or order to produce input data. The test data may be predefined according to a temporal sequence or order or according to a sequence or order that is determined on the basis of volumes of data. Accordingly, the processed test data can be easily identified in the stream of output data according to the temporal sequence or according to the order determined on the basis of volumes of data.

In some embodiments, the method involves the operative data and the test data being merged randomly and/or pseudorandomly in respect of a sequence or order to produce input data. The random and/or pseudorandom sequence or order is expediently logged so that the sequence or order can be taken as a basis for easily identifying the processed test data from the stream of output data.

The two preceding embodiments involve the processed test data being extracted from the output data on the basis of the sequence or order. The sequence or order can be taken as a basis for easily identifying the test data from the stream of output data. In some embodiments, the sequence or order is held or buffer-stored in a main memory, and the sequence or order is used to identify that portion of the output data that is formed by the processed test data.

In some embodiments, the test data form a portion of the input data that has no need of the data processing by means of the trusted execution environment. In this way, the test data do not need to be specially added to the operative data to generate input data for the trusted execution environment, but rather the operative data can be used as envisaged. In this embodiment, a portion of the originally operative data is declared as test data instead. The remaining operative data, which do not form test data, now form new operative data for the purposes of the present disclosure. The test data are not processed solely within the trusted execution environment, but rather the test data are processed outside the trusted execution environment at the same time in order to obtain reference data for the comparison. This development of the invention may be advantageous in particular if the essence of the operative data means that it is not critical if a subset thereof is processed outside the trusted execution environment as test data.

In some embodiments, the apparatus is a computer program product designed to carry out one or more of the methods as described herein. In some embodiments, the apparatus comprises a test data generator that is designed and configured to form test data. In some embodiments, the apparatus also comprises a test data mixing unit that is designed to merge the test data with the operative data. In some embodiments, the apparatus comprises a test data separating unit that is designed and configured to separate the processed test data from the processed operative data, with the result that one data stream of processed test data and another data stream of processed operative data can be formed.

In some embodiments, the apparatus comprises a test data verification unit that is designed and configured to verify the processed test data on the basis of reference data, i.e. to subject the test data to a comparison with the reference data. In some embodiments, the apparatus comprises an output data switching apparatus that releases the output data if the processed test data match the reference data, with the result that operative data processed with integrity can be output. In some embodiments, the output data switching apparatus is designed in such a way that it does not release the output data if the processed test data do not or do not adequately match the reference data. The output data are expediently not output by the apparatus in this case due to the absence of release.

The test data generator and/or test data mixing unit and/or test data separating unit and/or test data verification unit and/or output data switching apparatus may each be realized as a software component and/or software module and/or as a hardware device.

Some embodiments include a data processing installation comprising an apparatus as described hereinabove. Some embodiments include a plant comprising a production and/or machining plant and/or an autonomous vehicle and/or a medical device, e.g. a modality device such a medical device configured and designed for imaging methods, and comprises a data processing installation as described herein and/or an apparatus as described herein.

The teachings of the present disclosure are explained in more detail below on the basis of an exemplary embodiment shown in the drawing. The drawing shows an apparatus for determining the integrity of data processing of operative data by means of a trusted execution environment that is used to carry out one or more of the methods incorporating teachings of the present disclosure for determining the integrity of the data processing, schematically in a block diagram.

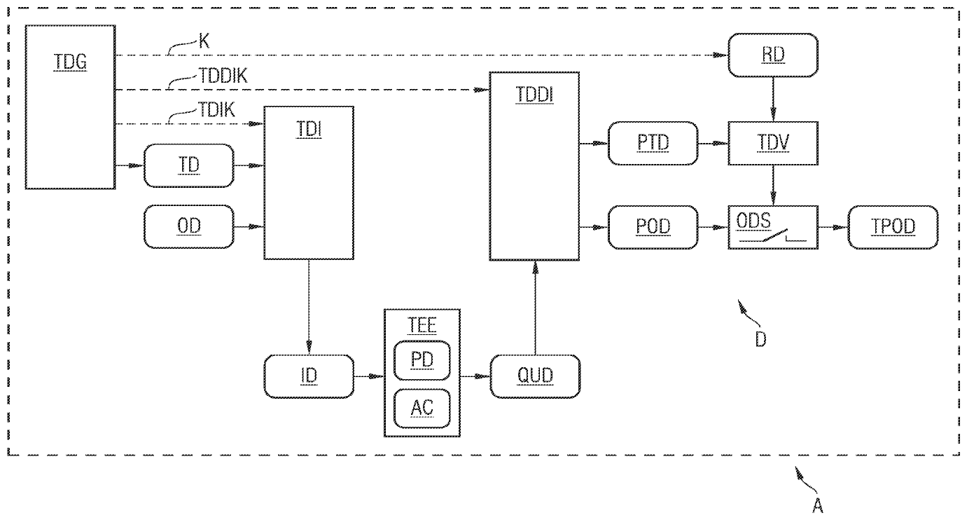

The method may be used to perform a runtime test to determine the integrity of the data processing of a trusted execution environment TEE. The method may be carried out using a data processing installation D, shown in FIG. 1, that comprises the trusted execution environment TEE. The trusted execution environment TEE shown is also known as an enclave or confidential computing execution unit. A program code AC, here in the form of an application is executed in the trusted execution environment TEE. In other embodiments, which are not shown specially, a program code in the form of a container or of an enclave code may be available instead of an app. The program code AC of the trusted execution environment TEE processes a stream of input data ID and outputs the processed input data PD as a stream of output data OUD.

The input data ID contain operative data OD, which necessarily need to be processed by means of the program code AC of the trusted execution environment TEE. The input data ID can be transmitted to the trusted execution environment TEE in clear text, for example. In other exemplary embodiments, which are not shown specially, the input data ID are transmitted to the trusted execution environment TEE in a cryptographically protected manner and in a manner authenticated by means of a secure communication channel, for example by means of a TLS channel with attestation of the TEE execution environment and of the program code AC executed therein.

In some embodiments, the trusted execution environment TEE can provide an attestation that confirms the architecture of the trusted execution environment, expediently Intel SGX, AMD SEV or ARM TrustZone, and its version and documents which program code AC is executed therein. The runtime test on the trusted execution environment TEE is performed by adding test data TD to the stream of input data ID that contains the operative data OD for data processing by means of the program code AC. The test data TD are randomly generated, for example. In some embodiments, the test data TD may alternatively also be firmly predefined or can be ascertained adaptively on the basis of the operative data OD.

In the exemplary embodiment shown, the test data TD are transmitted alternately (that is to say to a certain extent in an interleaved manner) with the operative data OD in sections. In some embodiments, the test data TD can be merged with the operative data OD in another way, for example by means of convolution or superimposition. The program code AC executed in the trusted execution environment TEE cannot clearly identify which portion of the input data ID forms operative data OD and which portion of the input data ID forms test data TD. In particular, this makes it difficult to deliberately manipulate the trusted execution environment, in particular the program code AC.

The trusted execution environment TEE uses the program code AC to process the input data ID containing the operative data OD and the test data TD to produce processed data PD. The processed data PD are output by the trusted execution environment TEE as output data OUD. The output data OUD therefore contain processed operative data POD and processed test data PTD. The processed test data PTD are verified by means of a test data verification unit TDV. On the basis of the verification, the processed operative data POD are provided or are provided in a modified manner by flagging them as “not trusted”, or the processed operative data POD are blocked or replaced with substitute data.

By way of example, the processed test data PTD have their content verified, for example by checking for a match between the processed test data PTD and an expected reference datum RD. In some embodiments, side channel effects, in particular electromagnetic radiation and power consumption and also memory access and bus access by the trusted execution environment TEE, are additionally detected and checked for plausibility by comparing whether the side channel effects have a pattern that corresponds to the test data TD.

The addition of test data TD to the stream of operative data OD and the checking of the processed test data PTD take place outside the trusted execution environment TEE in which the aforementioned monitored program code AC is executed. In the exemplary embodiment shown, this takes place in an open execution environment of the data processing installation D, but in other exemplary embodiments, can also take place in another trusted execution environment. By way of example, such other trusted execution environments are realized on a processor chip on which the trusted execution environment TEE described above is also realized or on a separate further processor chip or on a processor chip of an outside host.

In the exemplary embodiment shown, the test data TD are generated by means of a test data generator TDG and merged, that is to say to a certain extent “interwoven”, with the operative data OD by means of a test data interleaver TDI to form the input data ID for the trusted execution environment TEE.

The output data OUD output by the trusted execution environment TEE are separated again by a test data de-interleaver TDDI to form one data stream of processed test data PTD and another data stream of processed operative data POD. The processed test data PTD are verified by the test data verification unit TDV on the basis of reference data RD by comparing the processed test data PTD with the reference data RD.

If the result of the comparison is that the processed test data PTD match the reference data RD, the processed operative data POD are regarded as having integrity and the processed operative data POD are output by an output data switching apparatus ODS as operative data TPOD processed in a trusted manner.

In the exemplary embodiment shown, the test data TD and the associated reference data RD may be firmly predefined. However, the test data TD may be generated dynamically, for example randomly or pseudorandomly. In this case, the test data generator TDG provides not only the test data TD but also the reference data RD for verification and transfers them to the test data verification device TDV by means of a communication channel K.

The type of merging of test data TD and operative data OD may be firmly predefined. As such, by way of example, time intervals can be predefined in which test data TD are transferred as input data ID, while operative data OD are transferred as input data ID in other time intervals. In principle, test data can also be inserted into the stream of input data ID dynamically, for example randomly or pseudorandomly. In this case, the test data generator TDG also provides, in addition to the content test data TD, information TDDIK regarding how the test data need to be combined with the operative data. This information TDDIK is used by the test data interleaver TDI and by the test data de-interleaver TDDI. This flexible, dynamic way of combining operative data OD and test data TD has the advantage that errors or back doors in a trusted execution environment TEE or in an execution code AC executed therein can be easily detected, since a systematically erroneous or manipulated realization cannot be deliberately geared to a specific type of interleaving, i.e. to a specific type of combination of the test data TD with the operative data OD.

In some embodiments, instead of combining or interweaving test data TD and operative data OD in the test data interleaver TDI, it is also possible for a subset of operative data to be selected that are intended to be used as a set of test data TD: an input data selection device selects a subset of the operative data as test data TD and computes the reference data RD therefrom by applying the same computing operations thereto as are also applied in the trusted execution environment TEE. The portion of the operative data that does not form test data TD forms a new set of operative data OD for the purposes of the present disclosure. This selection of test data TD can be made according to firmly predefined rules or dynamically, e.g. randomly. The information regarding which data were selected as test data TD is presented to an output data selection device that selects from the output data OUD the processed test data PTD associated with the test data TD. The processed test data PTD are compared with the reference data RD as described above.

The above-described data processing installation D with the trusted execution environment TEE is part of a production plant A that processes confidential production schedules in the trusted execution environment TEE that are executed to produce workpieces. In some embodiments, the data processing installation D is part of a machining plant that processes confidential machining plans in the trusted execution environment TEE to machine workpieces.

What is claimed is:

1. A method for determining the integrity of data processing of operative data using a trusted execution environment, the method comprising:
presenting the trusted execution environment with input data including the operative data and test data;
processing the input data to produce output data;
subjecting that portion of the output data formed by the processed test data to a comparison with reference data; and
using the comparison as a basis for determining the integrity of the data processing.

2. The method as claimed in claim 1, further comprising:
establishing the integrity of the data processing is established; and
displaying a value of the integrity on a user interface if the reference data match the processed test data.

3. The method as claimed in claim 1, wherein data processing takes place in an encrypted manner.

4. The method as claimed in claim 1, further comprising merging the operative data and the test data according to a predefined sequence or order to produce input data.

5. The method as claimed in one of the preceding claims, wherein the operative data and the test data are merged randomly and/or pseudorandomly in respect of a sequence or order to produce input data.

6. The method as claimed in claim 3, further comprising extracting the processed test data from the output data on the basis of the sequence or order.

7. The method as claimed in claim 1, wherein the test data form a portion of the input data that has no need of the data processing by means of the trusted execution environment.

8-10. (canceled)
